(19) United States
(12) Patent Application Publication
(10) Pub. No.: US 2006/0080143 A1
(43) Pub. Date: Apr. 13, 2006

(54) Radiography system and management program thereof

(75) Inventors: Hisanori Tsuchino, Tokyo (JP); Yasuaki Tamakoshi, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/228,981

(22) Filed: Sep. 17, 2005

(30) Foreign Application Priority Data
Sep. 24, 2004 (JP) 2004-276936

(51) Int. Cl. G06Q 10/00

(52) U.S. Cl. 705/2

(57) ABSTRACT

A radiography system includes: a plurality of radiographic image detecting apparatus to obtain radiographic image information of a subject by radiography of the subject; a radiography operation control apparatus to control a radiography operation of at least one radiographic image detecting apparatus among the plurality of radiographic image detecting apparatus; and a management apparatus to manage the plurality of radiographic image detecting apparatus, wherein each of the plurality of radiographic image detecting apparatus is provided with an individual information storage unit to store individual information of the radiographic image detecting apparatus, and the individual information storage unit stores at least identification information specific to each of the plurality of radiographic image detecting apparatus, and wherein the management apparatus recognizes the identification information specific to each of the plurality of radiographic image detecting apparatus, and manages each of the plurality of radiographic image detecting apparatus based on the recognized identification information.

### BACKGROUND OF THE INVENTION

1. Field of the Invention

The present invention relates to a radiography system and a management program thereof.

2. Related Art of the Invention

Conventionally, in a medical diagnosis, radiographic images each obtained by radiating radiation such as an X-ray to a subject and by detecting an intensity distribution of the radiation having transmitted the subject have been widely used. In recent years, a radiography system using a flat panel detector (FPD) that is a radiographic image detecting apparatus for detecting radiation and converting the detected radiation into an electric signal to obtain radiographic image information, has been proposed.

In the radiography system, there is known a system constructed in order that an FPD provided in a radiographing room may be used in a state of being connected to a predetermined radiography operation control apparatus (controller) such as a personal computer (PC) to control a radiography operation through a predetermined communication line in order to improve the degree of freedom of the configuration of the system (see, for example, JP-Tokukai-2003-199736A).

Moreover, a cassette type FPD in which the FPD is housed in a cassette for the purpose of improving the conveyance property and the handling property of the FPD has been also developed (see, for example, JP-Tokukai-Hei 6-342099A). Furthermore, there has been also proposed a system in which a cassette type FPD and a radiography operation control apparatus are constructed as a system by a wireless system in order to be able to communicate various kinds of information such as radiographic image information (see, for example, JP-Tokukai-2003-210444A).

Now, after radiography, it is generally necessary to confirm whether radiography has been performed properly or not. In the radiography system mentioned above, a radiographic image is displayed on a computer. For example, in the radiography system shown in JP-Tokukai-2003-199736A, in which the FPD and the radiography operation control apparatus are constructed to be connected to each other through a communication line dedicated to the system, a radiography state can be confirmed by transmitting radiographic image information to the radiography operation control apparatus from the FPD, and by displaying on a computer reduced images such as thumbnail images produced based on the radiographic image received by the radiography operation control apparatus.

However, because the degree of freedom of a system configuration becomes small when the FPD and the radiography operation control apparatus are constructed by being connected to each other through the communication line dedicated to the system, it is conceivable to construct a system in which the FPD and the radiography operation control apparatus are connected to each other through an existing network such as Ethernet (registered trademark) But, in this case, the communication of the radiographic image information takes a long time, and it becomes hard to perform the confirmation of the radiography state immediately after the radiography.

Accordingly, with regard to the FPD, there has been proposed a system configuration in which, after producing reduced image information having a smaller information amount than the radiographic image information, the produced reduced image information is transmitted to the radiography operation control apparatus to display the reduced image on the computer.

Now, in general medical facilities, a plurality of radiographing rooms, in which radiography of a radiographic image is performed, is installed in many cases. In such a case, in order to control radiography operations in each radiographing room, one radiography operation control apparatus is provided in each radiographing room. Then, the radiography operation control apparatus in the radiographing room manages all FPD's used in the room.

Moreover, for example, U.S. Pat. No. 5,844,961B describes giving an ID for identifying an FPD to every FPD, and giving ID data of the FPD to the image data obtained from the FPD to transmit the image data to a PC. However, U.S. Pat. No. 5,844,961B does not describe managing the ID of an FPD on the side of a control apparatus which is formed as a separated body from the FPD, and which controls the FPD.

Moreover, for example, U.S. Pat. No. 6,795,572B describes the following correction method. That is, a serial number is stored to every sensor. When each sensor is connected to a host, the serial number is transmitted to the host. A hard disk, in which ID information and a correction table are stored, is searched. Then, the data of the correction table-according with ID information is obtained. The correction is performed based on the data. However, U.S. Pat. No. 6,795,572B describes only the use of the correction of image data.

It is an object of the present invention to provide a radiographic image system and a management program which can manage a radiographic image detecting apparatus easily with the radiography operation control apparatus at a moved place even if the radiographic image detecting apparatus has moved.

### SUMMARY OF THE INVENTION

In order to solve the above-mentioned problem, in accordance with the first aspect of the present invention, a radiography system includes:

a plurality of radiographic image detecting apparatus to obtain radiographic image information of a subject by radiography of the subject;

a radiography operation control apparatus to control a radiography operation of at least one radiographic image detecting apparatus among the plurality of radiographic image detecting apparatus; and

a management apparatus to manage the plurality of radiographic image detecting apparatus, wherein each of the plurality of radiographic image detecting apparatus is provided with an individual information storage unit to store individual information of the radiographic image detecting apparatus, and the individual information storage unit stores at least identification information specific to each of the plurality of radiographic image detecting apparatus, and wherein

the management apparatus recognizes the identification information specific to each of the plurality of radiographic image detecting apparatus, and manages each of the plurality of radiographic image detecting apparatus based on the recognized identification information.

In accordance with the second aspect of the invention, a management program causes a computer, which is included in a management apparatus to manage a plurality of radiographic image detecting apparatus to obtain radiographic image information of a subject by radiography of the subject, to execute a method comprising:

recognizing identification information specific to each of the plurality of radiographic image detecting apparatus; and

managing each of the plurality of radiographic image detecting apparatus based on the recognized identification information.

### BRIEF DESCRIPTION OF THE DRAWINGS

FIG. 1 is a view showing a schematic configuration of a radiography system exemplified as an embodiment to which the present invention is applied;

FIG. 2 is an explanatory diagram showing the configuration of the principal part of the radiographic image radiographing apparatus constituting the radiography system of FIG. 1;

FIG. 3 is a block diagram showing the configuration of the principal part of a radiographic image detecting apparatus constituting the radiography system of FIG. 1;

FIG. 4 is a block diagram showing the configuration of the principal part of a console constituting the radiography system of FIG. 1;

FIG. 5 is a block diagram showing the configuration of the principal part of a server constituting the radiography system of FIG. 1;

FIG. 6 is a flowchart showing the operation of the radiographic image detecting apparatus of FIG. 3;

FIG. 7 is a flowchart showing the operation of the console 3 of FIG. 4; and

FIG. 8 is a timing chart showing an example of the operation according to the radiography processing by the radiography system of FIG. 1.

### DETAILED DESCRIPTION OF THE PREFERRED EMBODIMENTS

According to a radiography system or a management program, because a management apparatus manages each of a plurality of radiographic image detecting apparatus-based on identification information specific to the radiographic image-detecting apparatus, the plurality of radiographic image detecting apparatus can be unitarily managed. Thereby, the efficiency of the whole radiography work flow is improved.

For example, because the information acquisition of each radiographic image detecting apparatus can carry out easily by managing a plurality of radiographic image detecting apparatus unitarily, a prior state check can be efficiently made, or the specification of the radiographic image detecting apparatus which has caused a problem can also be efficiently performed as a result.

Moreover, it is preferable that the radiography system is provided with a communication line connecting at least one of the radiographic image detecting apparatus, the radiography operation control apparatus and the management apparatus, and that the management apparatus manage the plurality of radiographic image detecting apparatus based on the identification information taken in through the communication line.

Thus, the management apparatus manages the plurality of radiographic image detecting apparatus based on the identification information taken in through the communication line. Thereby, even if the radiographic image detecting apparatus has moved on the communication line, the management apparatus takes in the identification information at the moved place through the communication line, and confirms the taken identification information. Herewith, even if the radiographic image detecting apparatus has moved, the radiographic image detecting apparatus can be easily managed.

Moreover, it is preferable that one of the radiography operation control apparatus is commonly used also as the management apparatus.

Because one radiography operation control apparatus among the plurality of radiography operation control apparatus is used as the management apparatus, the configuration of the system can be simplified in comparison with the case where the management apparatus is installed as a single body.

Then, it is preferable that the radiography operation control apparatus is an image processing apparatus performing image processing to the radiographic image information which has been obtained by the radiographic image detecting apparatus and has been input through the communication line.

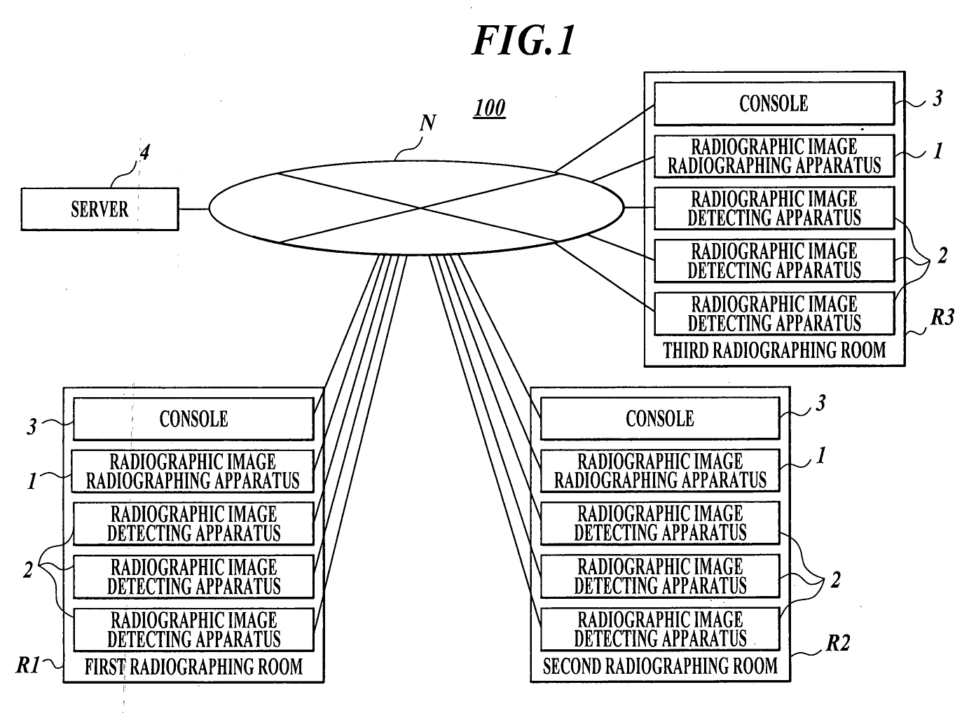

Thus, when the radiography operation control apparatus is the image processing apparatus, the image processing of the radiographic image information can be performed even if the image processing apparatus is not connected to the communication line as a separated body, and the configuration of the system can be simplified Hereinafter, referring to the attached drawings, the preferred embodiments of the present invention are described in detail. Although affirmative expressions and explanatory expressions are shown in the following descriptions and drawings, those specify and describe the embodiments considered to be the best ones of the present invention, and they do not limit the meanings of the terms of the present invention and the scope of the present invention. Moreover, the scope of the invention is not limited to the shown examples. FIG. 1 is a view showing the schematic configuration of a radiography system exemplified as an embodiment to which the present invention is applied.

As shown in FIG. 1, a radiography system 100 comprises, for example, three radiographing rooms, a first radiographing room R1, a second radiographing room R2 and a third radiographing room R3. In each of the first radiographing room R1, the second radiographing room R2 and the third radiographing room R3, there are installed a radiographic image radiographing apparatus 1 radiating radiation such as an X-ray to a subject at the time of the radiography of the subject, a plurality of radiographic image detecting apparatus 2 obtaining radiographic images of the subject, and a console 3, which performs the control of the radiography operations of the radiographic image detecting apparat s 2installed in each of the radiographing rooms R1, R2 and R3, the display of radiographic images, and the image processing of radiographic images. Then, each apparatus of each radiographing rooms R1, R2, and R3 is connected to one another through a network N. A server (management apparatus) 4, which manages all the radiographic image detecting apparatuses 2 on the network N, is connected to the network N.

Hereupon, although the network N may be a communication line only for the system, it is more preferable to be an existing circuit such as Ethernet (registered trademark) because of the reason of the lowering of the degree of freedom of the system configuration.

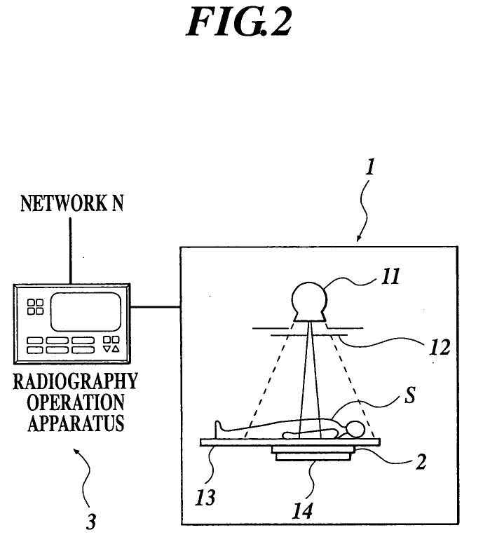

The radiographic image radiographing apparatus 1 is described in detail with reference to FIG. 2. Here, FIG. 2 is an explanatory diagram showing the configuration of the principal part of the radiographic image radiographing apparatus 1. The radiographic image radiographing apparatus 1 is used in the state of being installed in a radiographing room in a hospital, for example. The radiographic image radiographing apparatus 1 includes a radiation source (radiation radiating means) 11, and generates radiation by the application of a tube voltage to the radiation source 11. An iris device 12 adjusting a radiation radiating field is provided at the radiation radiating port of the radiation source 11 in the sate of being freely openable and closable. A bed 13, on which a patient S is laid, is provided in a radiation radiating range below the radiation source 11. Then, a detecting apparatus installing port (not shown) for installing the radiographic image detecting apparatus 2, which reads the strength of radiation and detects a radiographic image, is provided below the bed 13. A photo timer 14 is provided under the detecting apparatus installing port. The photo timer 14 detects a radiation dose having transmitted the patient S, and transmits a signal instructing the stop of the radiation of radiations from the radiation source 11 to the console 3 when the radiation dose having transmitted the patient S has reached a predetermined dose.

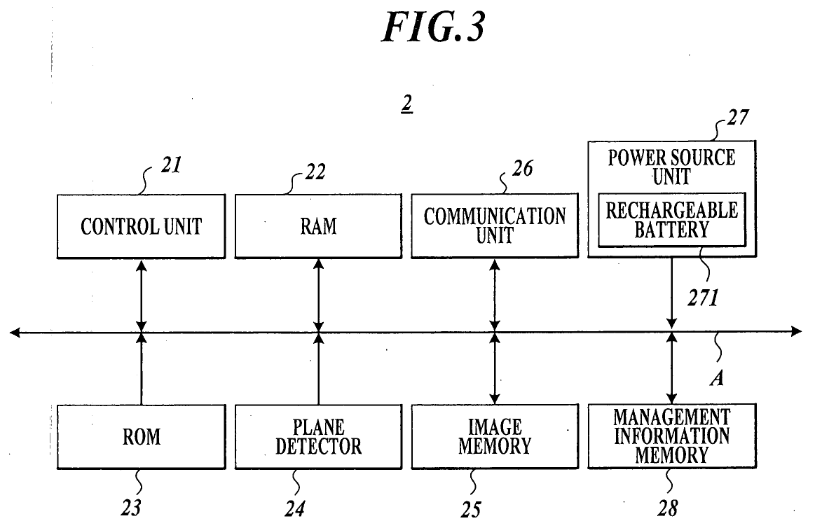

Below, referring to FIG. 3, the radiographic image detecting apparatus 2 is described in detail. Hereupon, FIG. 3 is a block diagram showing the configuration of the principal part of the radiographic image detecting apparatus 2.

Each of the plurality of radiographic image detecting apparatus 2 is a cassette type FPD housed in a cassette, for example, as shown in FIG. 3, in the state in which a control unit 21, a RAM 22, a ROM 23, a plane detector (radiation detecting unit) 24, an image memory 25, a communication unit 26, a power source unit 27, a management information memory 28 and the like are connected to one another through a bus A.

The random access memory (RAM) 22 is, for example, a volatile semiconductor memory, and constitutes a working space (illustration is omitted) of various programs or the like executed by the control unit 21.

The read only memory (ROM) 23 is a read only memory, and stores, for example, individual information including various programs, identification information for identifying the radiographic image detecting apparatus 2 and the like.

As the various programs, there can be cited an obtainment control program for obtaining the radiographic image information of a subject from the plane detector 24, an image storage control program for making the image memory 25 store the obtained radiographic image information, a displaying information generation program for generating displaying image information to be outputted to the console 3 based on the radiographic image information, an associating program for associating the displaying image information generated by the displaying information generation program with the radiographic image information, a radiographic image correction program for correcting the radiographic image information, a displaying image correction program for correcting the displaying image information, a correcting information obtaining program for obtaining correcting information pertaining to the correction of a radiographic image, a judgment program for judging whether the radiographic image information may be transmitted to the console 3 or not, and the like.

The identification information is the information specific to each of the plurality of radiographic image detecting apparatus 2 connected to the network N, and the information attached to each radiographic image detecting apparatus individually so as not to overlap with one another in order to identify each of the plurality of radiographic image detecting apparatus 2. As the identification information, for example, a production number, an ID number and the like can be cited. That is, the ROM 23 is the individual information storage unit which stores the identification information according to the present invention.

The plane detector 24 is one in which a plurality of pixels are arranged in a matrix on a predetermined substrate such as a glass substrate. Each of the pixels detects the radiation which has been radiated from the radiation source 11 and has transmitted at least a subject according to the intensity of the radiation, and converts the detected radiation into an electric signal to store the converted electric signal.

Hereupon, as the plane detector 24, although the illustration thereof is omitted, for example, there can be cited an indirect type plane detector equipped with a radiation-light conversion layer converting radiation into fluorescence (light) and a photoelectric conversion layer detecting the fluorescence converted by the radiation-light conversion layer to convert the florescence into an electric signal, and direct type one it changes to a radiation-light conversion layer and a photoelectric conversion layer, and a direct type plane detector equipped with a radiation-electric signal conversion layer including a radiation reception unit converting radiation into an electric signal directly in place of the radiation-light conversion layer and the photoelectric conversion layer, and the like.

The image memory 25 stores the radiographic image information obtained by the reading of the electric signal stored in the plane detector 24 under the control of the control unit 21. In concrete terms, the image memory 25 comprises a nonvolatile memory such as a flash memory. The storage capacity of the image memory 25 is the size capable of storing at least two radiographic images. Incidentally, the upper limit of the storage capacity is suitably set depending on the configuration of the radiography system 100 and the like, and, for example, is a size capable of storing about ten radiographic a images.

The communication unit 26 performs communication of various kinds of information with the console 3 and the server 4 by a radio communication system such as a wireless local area network (LAN). The communication unit 26 transmits (outputs) the reduced image information which has been generated by the control unit 21 and has received a predetermined image correction. Moreover, the communication unit 26 transmits the key information for associating the reduced image information which has been generated by the control unit 21 and is transmitted to the console 3 with the radiographic image information stored in the image memory 25 to the console 3. Then, the communication unit 26 outputs the radiographic image information which is stored in the image memory 25 and has received an image correction (which will be described later) to the console 3. Moreover, the communication unit 26 receives a radiography operation signal for controlling a radiography operation from the console 3.

The power source unit 27 includes a rechargeable battery 271, which supplies a power source to each unit constituting the radiographic image detecting apparatus 2, and is constructed to be chargeable through a recharging terminal (the illustration thereof is omitted) provided at a predetermined position of the radiographic image detecting apparatus 2.

The management information memory 28 stores the identification information, i.e. the information specific to the radiographic image detecting apparatus 2, and management information such as the information pertaining to the radiographic image detecting apparatus 2. Incidentally, the identification information stored in the management information memory 28 is the information copied from the identification information stored in the ROM 23. The management information memory 28 comprises a nonvolatile memory such as a flash memory. Hereupon, as the management information, in addition to the identification information, there can be cited, for example, the initial data such as the size and the sensitivity of the radiographic image detecting apparatus 2, image correcting data to perform the image correction suitable for the radiographic image detecting apparatus 2, the battery data such as the residual quantity and the exchange time of the rechargeable battery 271, cumulative number of times of radiographing, and the like.

The control unit 21 comprises, for example, a central processing unit (CPU) and the like. The control unit 21 reads a predetermined program stored in the ROM 23, expands the read program in the working space of the RAM 22, and executes various kinds of processing according to the program. For example, the control unit 21 controls a switching unit such as a thin film transistor (TFT) constituting each pixel of the plane detector 24 based on the radiography operation signal transmitted from the console 3 according to the obtained control program. After that, the control unit 21 sequentially performs the switching of the reading of electric signals stored in each pixel, reads all the electric signals stored in the plane detector 24, and converts the read electric signals into digital signals. Thereby, the control unit 21 obtains the radiographic image information of the subject from the plane detector 24.

Moreover, the control unit 21 makes the image memory 25 store the obtained radiographic image information before the new radiography of the subject according to the image storage control program. At this time, the control unit 21 makes the image memory 25 store the radiography date and time and identification information as the accompanying information of the radiographic image information after the control unit 21 has obtained the radiography date and time and the identification information of the radiographic image detecting apparatus 2 stored in the ROM 23. Furthermore, the control unit 21 updates the management information changed by the radiography at this time, and makes the management information memory 28 store the management information.

Moreover whenever the control unit 21 obtains the radiographic image information, the control unit 21 generates the displaying image information to be outputted to the console 3 based on the obtained radiographic image information according to the displaying information generation program. In concrete terms, the control unit 21 generates reduced image information having an amount of information less than that of the radiographic image information as the displaying image information. The reduction ratio of the reduced image is preferably, for example, a reduction ratio by which the pixel numbers of the row direction and the column direction of the original image become those of from ½ to 1/100 times (the reduction ratio by which the total number of pixels becomes ones from ¼ to 1/10000 times), and the reduction ratio is more preferably one by which the total number of pixels becomes ¼ to 1/2500 times. Then, also in the displaying image information generated based on radiographic image information in this manner, the accompanying information of the radiographic image information mentioned above is given.

Hereupon, the generation of a displaying image by the control unit 21 may be performed before the storing of the radiographic image information to the image memory 25, or it may be performed after the storing of the radiographic image information.

Furthermore, the control unit 21 generates the key information for associating the displaying image information generated by the control unit 21 with the radiographic image information stored in the image memory 25 according to an associating program. The key information is preferably the information specific to the radiographic image information which exists in the image memory 25 at the same time. The key information may be an image ID specific to the radiographic image information within a suitable range such as the inside of the whole world, an area or an institution, or may be one piece of the following information: radiography time information indicating a radiography time, the address information corresponding to a storage address on the image memory 25, the storage order information pertaining to the storage in the image memory 25, and the other information as long as the information can associate the displaying image information with the radiographic image information stored in the image memory 25.

Moreover, the control unit 21 corrects the obtained radiographic image information according to the radiographic image correction program, or corrects the generated displaying image information according to the displaying image correction program. In concrete terms, the present embodiment performs a the fixed pattern noise (FPN) correction correcting the dark current stored in semiconductors such as amorphous silicon (a-Si) constituting the plane detector 24 as time elapses, the white correction (gain correction) correcting the dispersion of the gain of every pixel of the plane detector 24, and the like. In these image corrections, the control unit 21 obtains the correction information pertaining to the correction of a radiographic image according to the correcting information obtaining program. In concrete terms, for example, the control unit obtains a dark current signal (FPN signal) in the FPN correction, or obtains white image data in the white correction.

Below, the FPN correction and the white correction are described still in detail.

The FPN correction is an image correction obtaining a true image signal by removing the FPN signal which is included in the image signal obtained by radiography and becomes a noise, from the image signal. Hereupon, the FPN signal is generally a function of temperature and storing time, and a radiography time differs every radiography portion and subject. Accordingly, when the FPN correction is performed, the storage time of the plane detector 24 is measured every radiography, and after the radiography the dark current is stored for a time almost equal to the measured storage time in the state where no X-rays are radiated to the plane detector 24. After that by reading a signal from the plane detector 24, a FPN image signal almost equal to the FPN signal included in the radiography image is obtained. By subtracting the FPN image signal from the image signal obtained by the radiography of the subject, a true image signal can be obtained.

Moreover, in the white correction, first, the white image data (Log value) is subtracted from the image signal which has received a logarithmic (Log) conversion after the FPN correction, for example. Hereupon, the white image data is the image data obtained by radiating a uniform radiation on the whole of the plane detector 24 without through a subject, and the obtained white image data is stored in predetermined memory means. Incidentally, the obtainment of the white image data is periodically performed, for example, every morning, once in a week, or the like.

Moreover, the control unit 21 judges whether the radiographic image information stored in the image memory 25 may be transmitted to the console 3 or not based on a radiography suitability signal transmitted form a communication unit 36 of the console 3 and received through the communication unit 26 of the radiographic image detecting apparatus 2 according to a judgment program. In more concrete terms, the control unit 21 judges whether the radiographic image information associated to the key information among the plurality of pieces of radiographic image information stored in the image memory 25 may be transmitted to the console 3 or not based on radiography suitability signal and the key information pertaining to the radiography suitability signal.

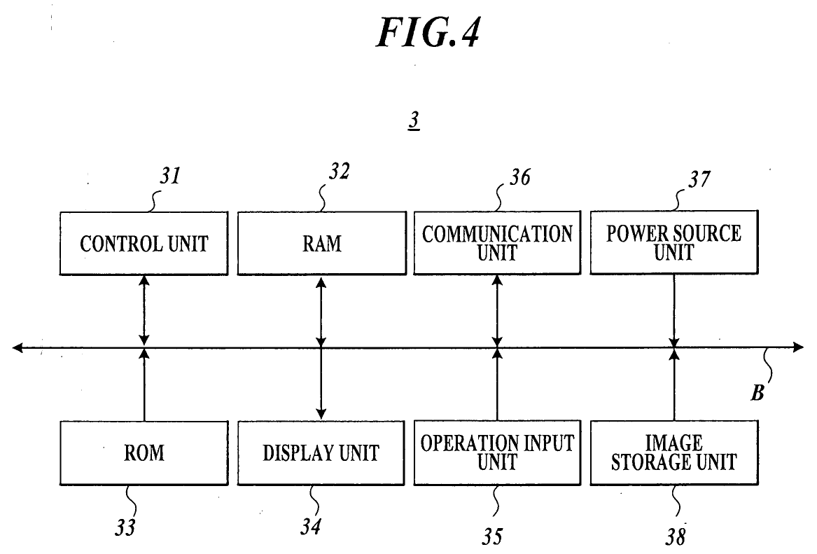

Next, the console 3 is described with reference to FIG. 4. FIG. 4 is a block diagram showing the configuration of the principal part of the console 3.

In order that a user may confirm whether radiography has been properly performed or not, the console 3 displays the radiographic image radiographed with the radiographic image detecting apparatus 2, performs predetermined image processing to the radiographic image, and controls the radiography operation of the radiographic image detecting apparatus 2. That is, the console 3 is commonly used as the radiography operation control apparatus and the image processing apparatus according to the present invention. As shown in FIG. 4, the console 3 comprises a control unit 31, a RAM 32, a ROM 33, a display unit 34, an operation input unit 35, the communication unit 36, a power source unit 37, an image storage unit 38 and the like. Each unit is connected to one another through a bus B.

The RAM 33 is, for example, a volatile semiconductor memory, and constitutes a working space (the illustration thereof is omitted) of various programs or the like executed by the control unit 31. Moreover, the RAM 32 stores reduced image information as a plurality of pieces of displaying image information output from the communication unit 26 of the radiographic image detecting apparatus 2 and input to the RAM 32. Incidentally the RAM 32 may be a nonvolatile memory.

The ROM 33 is a read only memory, and stores various programs to be executed by the control unit 31. As the various programs, there can be cited, for example, an image processing program for performing the image processing of a radiographic image, a control program for controlling the radiography operation of he radiographic image detecting apparatus 2, and the like.

The control unit 31 comprises, for example, a CPU and the like. The control unit 21 reads a predetermined program stored in the ROM 32, and expands the read program in the working space of the RAM 32. Then, the control unit 31 executes various kinds of processing according to the program. In concrete terms, the control unit 21 performs predetermined image processing such as the gradation processing, the γ conversion processing and the like of a radiographic image pertaining to the radiographic image information based on the radiographic image information transmitted from the communication unit 26 of the radiographic image detecting apparatus 2 and received through the communication unit 36 according to the image processing program.

Moreover, the control unit 31 produces a radiography operation signal based on the operation signal from the operation input unit 35, following a control program. After that, the control unit 31 outputs the radiography operation signal to the radiographic image detecting apparatus 2 through the network N, and controls the radiography operation of the radiographic image detecting apparatus 2.

The display unit 34 comprises, for example, a cathode ray tube (CRT), a liquid crystal display (LCD) or the like. The display unit 34 displays various screens on the display screen thereof depending on the instruction of the display signal output from the control unit 31 and input thereto. In concrete terms, the display unit 34 is constructed to be possible to perform the thumbnail display of a plurality of reduced images on the display screen thereof based on a plurality of pieces of reduced image information transmitted from the radiographic image detecting apparatus 2 and received through the communication unit 36.

Moreover, the display unit 34 displays on the display screen thereof a radiography operation instruction signal portion for instructing the input of a radiography operation instruction signal at the time of the radiography operation control of the radiographic image detecting apparatus 2, a radiography suitability instructing portion for instructing an input of the radiography suitability signal associated to each reduced image at the time of a display of the reduced images, for example, and the like. The radiography operation instruction signal portion and the radiography suitability instructing portion are displayed on the display screen of the display unit 34 so that the selection of the portions may be possible based on a predetermined operation of the mouse of the operation input unit 35 or the like.

The operation input unit 35 consists of a keyboard, a mouse and the like, and outputs a depression signal of a key the depression operation of which has performed and an operation signal of the mouse as input signals to the control unit 31. In concrete terms, the operation input unit 35 is constructed so as to output (input) a signal for moving a pointer on the display screen of the display unit 34, an image display instruction signal pertaining to a display instruction of a radiographic image, the radiography suitability signal pertaining to whether the radiography state of a radiographic image is proper or not, the radiography operation instruction signal to the radiographic image detecting apparatus 2, and the like.

Moreover, the operation input unit 35 may be constructed by the so-called touch panel outputting positional information input by touching a transparent sheet panel covering the display screen of the display unit 34 with a finger or a dedicated stylus pen to the control unit 31 as an input signal.

The communication unit 36 communicates various pieces of information with the communication unit 26 of the radiographic image detecting apparatus 2 by a radio communication system such as a wireless LAN. In concrete terms, the communication unit 36 receives the reduced image information and the key information which have been transmitted from the communication unit 26 of the radiographic image detecting apparatus 2. Moreover, the communication unit 36 transmits the radiography operation instruction signal and the radiography suitability signal which have been inputted by the operation input unit 35, and the key information associated to the reduced image information pertaining to the radiography suitability signal to the radiographic image detecting apparatus 2.

The power source unit 37 supplies a power source to each unit constituting the console 3. This power source unit 37 may be constructed to be equipped with a rechargeable battery constructed to be chargeable through, for example, a predetermined recharging terminal (the illustration thereof is omitted), and may be constructed to be equipped with a power source connection unit for being connected with an AC commercial power source.

The image storage unit 38 comprises, for example, a hard disk drive or the like. The image storage unit 38 constitutes an image database storing the radiographic image information pertaining to the radiographic image having received predetermined image processing under the control of the control unit 31.

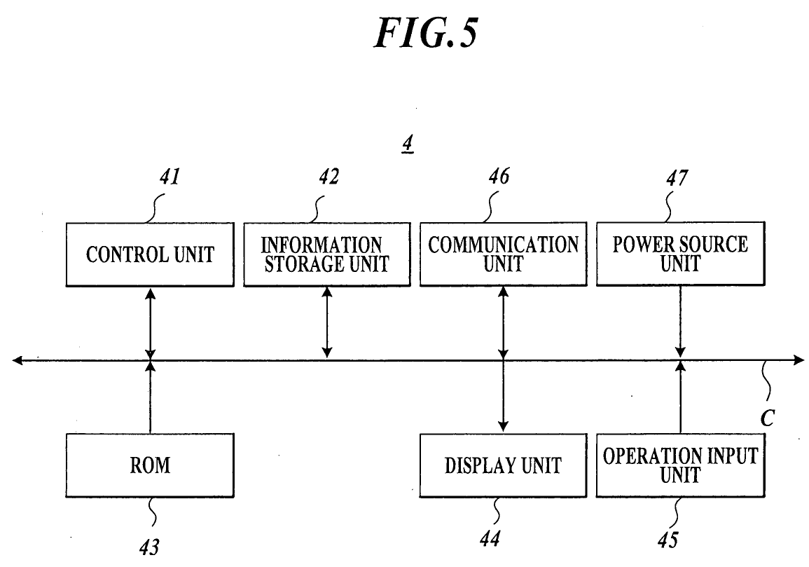

Next, the server 4 is described with reference to FIG. 5. FIG. 5 is a block diagram showing the configuration of the principal part of the server 4.

The server 4 manages all the radiographic image detecting apparatuses 2 on the network N. As shown in FIG. 5, the server 4 comprises a control unit 41, an information storage unit 42, a ROM 43, a display unit 44, an operation input unit 45, a communication unit 46, a power source unit 47 and the like. Each unit is connected to one another through a bus C.

The information storage unit 42 has, for example, a RAM that is, for example, a volatile semiconductor memory. The storage area of the information storage unit 42 includes, for example, a working space (the illustration thereof is omitted) of various programs executed by the control unit 41, the storage area (the illustration thereof is omitted) storing the identification information and the management information of the radiographic image detecting apparatus 2, and the like.

The ROM 43 is a read only memory, and stores various programs executed by the control unit 41 such as a management program for managing each radiographic image detecting apparatus 2.

The control unit 41 comprises, for example, a CPU and the like. The control unit 41 reads a predetermined program stored in the ROM 43, expands the read program in the working space of the information storage unit 42, and executes various kinds of processing according to the program. The management program for managing each radiographic image detecting apparatus 2 is included in the predetermined program. The management program makes the control unit 41 of the server 4 recognize the identification information individually given to teach of the plurality of radiographic image detecting apparatus 2, and makes the control unit 41 manage each of the plurality of radiographic image detecting apparatus 2 based on the recognized identification information. The control unit 41 manages each of the radiographic image detecting apparatus 2 based on the identification information and the management information of each of the radiographic image detecting apparatus 2, following the management program.

The communication unit 46 communicates various kinds of information with the radiographic image detecting apparatus 2 by a radio communication system such as a wireless LAN. In concrete terms, the communication unit 46 receives the identification information and the management information output from the communication unit 26 of the radiographic image detecting apparatus 2.

The display unit 44 and the operation input unit 45 is constructed to be almost equal to the configurations of the display unit 34 and the operation input unit 35 provided in the console 3, respectively.

Moreover, the power source unit 47 supplies a power source to each unit constituting the server 4.

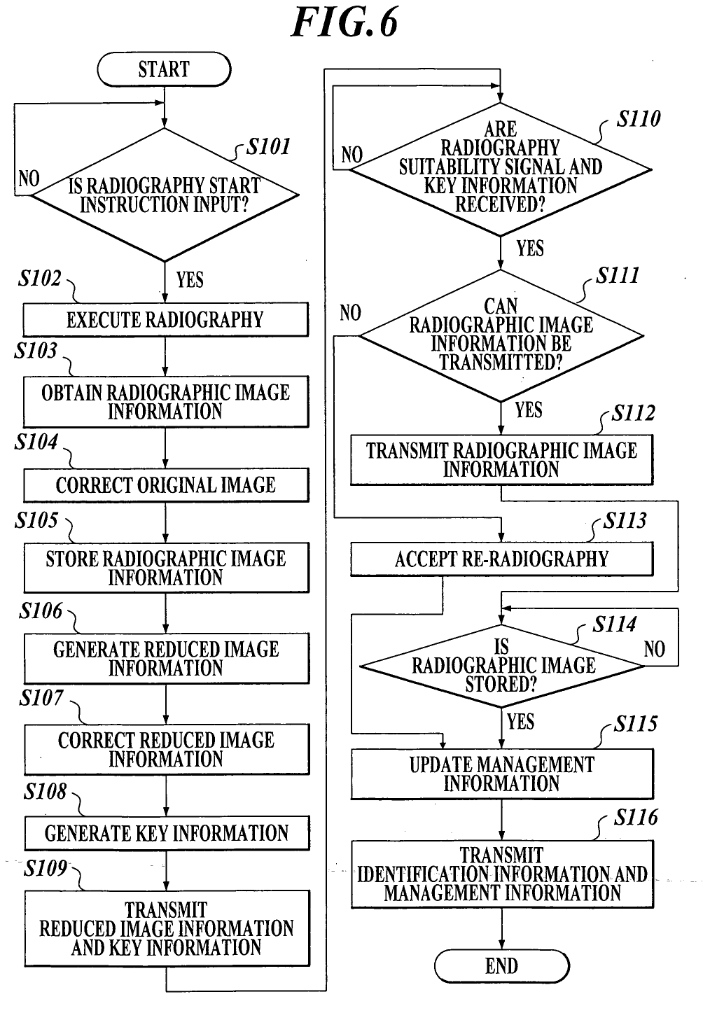

Next, the operation of the radiographic image detecting apparatus 2 is described, referring to the flowchart of FIG. 6. FIG. 6 is a flowchart showing the operation of radiographic image detecting apparatus 2.

First, the control unit 21 of the radiographic image detecting apparatus 2 judges whether a radiography start instruction is input into the communication unit 26 from the console 3 or not (Step S101). When the control unit 21 judges that the radiography start instruction is not input (Step S101: No), the control unit 21 keeps the station. When the control unit 21 judges that the radiography start instruction is input (Step S101: Yes), the processing of the control unit 21 shifts to Step S102.

At Step S102, the control unit 21 of the radiographic image detecting apparatuses controls the plane detector 24 of the radiographic image detecting apparatus 2 so that the plane detector 24 may detect radiation, convert the radiation into an electric signal, and store the electric signal in each pixel of the plan detector 24. Thereby, by the radiography start instruction, radiation is radiated from the radiographic image radiographing apparatus 1 to a subject, the radiation having transmitted the subject is detected by the plane detector 24 of the radiographic image detecting apparatus 2, and consequently the detected radiation is converted into an electric signal to be stored in each pixel of the plane detector 24.

Next, the control unit 21 of the radiographic image detecting apparatus 2 controls the plane detector 24 to read electric charges stored in each pixel of the plane detector 24, and digitize the read charges to send the digitized image signal to the control unit 21. Thereby, the control unit 21 obtains the radiographic image information (original image) of the subject (Step S103). In concrete terms, the control unit 21 reads an obtainment control program from the ROM 23, expands the read program in the RAM 22, and controls the switching unit of each pixel of the plane detector 24 so that the switching unit sequentially switches the reading of the electric signal stored in each pixel according to the obtainment control program. Thereby, the control unit 21 controls the plane detector 24 to read all of the electric signals stored in the plane detector 24 to digitize the read electric signals and transmit the digitized electric signal to the control unit 21.

Successively, the control unit 21 reads the radiographic image correction program from the ROM 23, and expands the read program in the RAM 22. Then, the control unit 21 performs the correction processing of an original image in which a predetermined image correction is performed to the obtained radiographic image information according to the radiographic image correction program (Step S104).

After that, the control unit 21 reads an image storage control program from the ROM 23, expands the read program in the RAM 22, and makes the image memory 25 store the radiographic image information and the accompanying information after correction according to the image storage control program (Step S105).

Next, the control unit 21 reads the displaying information generation program from the ROM 23, expands the read program in the RAM 22, and generates reduced image information having a less amount of information than that of the radiographic image information as a displaying image to be output to the console 3 based on the obtained radiographic image information according to the displaying information generation program (Step S106).

Successively, the control unit 21 reads the displaying image correction program from the ROM 23, expands the read program in the RAM 22, and performs a predetermined image correction to the reduced image information according to the displaying image correction program (Step S107).

Incidentally, the generation and the correction of the reduced image information are set to be performed every obtainment of the radiographic image information by the radiographic image detecting apparatus 2.

Next, the control unit 21 reads the associating program from the ROM 23, expands the read program in the RAM 22, and generates the key information for associating the reduced image information to be transmitted to the console 3 with the radiographic image information stored in the image memory 25 according to the associating program (Step S108).

After that, the control unit 21 controls the communication unit 26 to make the communication unit 26 transmit the generated reduced image information, the accompanying information thereof and the key information corresponding to the reduced image information together to the console 3 (Step S109).

At Step S110, the control unit 21 judges whether a radiography suitability signal and the key information are received from the console 3 or not. When the signal and the information are not received (Step S110: No), the control unit 21 keeps the state. When the signal and the information are received (Step S110: Yes), the control unit 21 shifts its processing to Step S111.

At Step S111, when the control unit 21 receives the radiography suitability signal and the key information, which has been transmitted from the communication unit 36 of the console 3, through the communication unit 26, the control unit 21 reads the judgment program from the ROM 23, expands the read program in the RAM 22, and judges whether the radiographic image information (original image) associated with the key information among the plurality of pieces of radiographic image information stored in the image memory 25 is transmitted to the console 3 or not based on each of the radiography suitability signal and the key information according to the judgment program. In concrete terms, when a signal including the information indicating that the radiography sate of a radiographic image is proper is input as the radiography suitability signal, the control unit 21 judges to transmit the radiographic image information (original image). On the other hand, when a signal including the information indicating that the radiography state of a radiographic image is not proper as the radiography suitability signal is input, the control unit 21 judges not to transmit the radiographic image information (original image).

Hereupon, when the control unit judges to transmit the radiographic image information (original image) to the console 3 (Step S111: Yes), the control unit 21 shifts its processing to Step S112. At Step S112, the control unit 21 obtains the radiographic image information from the image memory 25, and makes the communication unit 26 transmit the obtained radiographic image information (original image) to the console 3. After that, the control unit 21 shifts its processing to Step S114.

Incidentally, when the control unit 21 judges not to transmit the radiographic image information to the console 3 (Step S111; No), the control unit 21 shifts its processing to Step S113, and controls each unit of the radiographic image detecting apparatus 2 to make the apparatus 2 an acceptation state of re-radiography to shift its processing to Step S115.

At Step S114, the control unit 21 judges whether the radiographic image information is stored in the image storage unit 38 of the console 3 or not based on the existence of a storage completion signal (which will be described later) from the console 3. When the information is not stored in the unit 38 (Step S114: No), the control unit 21 keeps the state. When the information is stored in the unit 38 (Step S114: Yes), the control unit 21 shifts its processing to Step S115. Hereupon, the control unit 21 may be constructed to perform data deletion of the radiographic image information stored in the image storage unit 38 of the console 3, i.e. the radiographic image information unnecessary to be transmitted to the console 3.

At Step S115, the control unit 21 updates the management information changed by the radiography at this time (i.e. the exchange time of the rechargeable battery 271 and the total number of times of radiographing), and makes the management information memory 28 store the updated management information. After that, the control unit 21 makes the communication unit 26 transmit the updated management information and the identification information to the server 4 (Step S116).

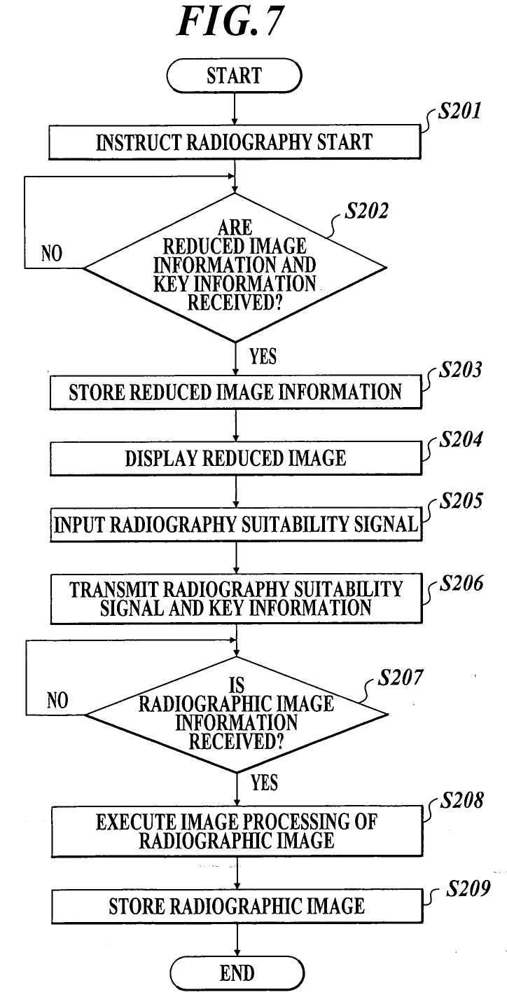

Next, the operation of the console 3 is described with reference to the flowchart of FIG. 7. FIG. 7 is a flowchart showing the operation of the console 3.

First, when a radiography start instruction signal is input into the operation input unit 35, the control unit 31 of the console 3 transmits the radiography start instruction signal to the radiographic image detecting apparatus 2 through the communication unit 36 (Step S201).

After that, at Step S202, the control unit 31 judges whether reduced image information and key information are received from the radiographic-image detecting apparatus 2 or not. When the information is not received (Step S202: No), the control unit 31 keeps the state. When the information is received (Step S202: Yes), the control unit 31 shifts its processing to Step S203.

At Step S203, when the control unit 31 receives the reduced image information and the key information transmitted from the communication unit 26 of the radiographic image detecting apparatus 2 through the communication unit 36, the control unit 31 stores the received reduced image information and the received key information in a predetermined region of the RAM 32.

Then, when an image display instruction signal pertaining to a display instruction of the reduced image information stored in the RAM 32 is input based on an operation of the operation input unit 35, the control unit 31 obtains a plurality of pieces of reduced image information corresponding to the image display instruction signal from the RAM 32, and controls the display unit 34 to display a plurality of reduced images as thumbnail displays on the display screen thereof based on the obtained reduced image information (Step S204). In concrete terms, the control unit 31 is adapted to make the display unit 34 display the plurality of reduced images and radiography suitability instructing portions associated=with the respective reduced images at predetermined positions on the display screen of the display unit 34. At this time, the accompanying information given to the reduced image information is displayed on each reduced image in association with each other.

Then, by the selection to be instructed of a radiography suitability instructing portion displayed on the display screen of the display unit 34 with a predetermined operation of the operation input unit 35 by a user, the radiography suitability signal pertaining to whether the radiography state of the radiographic image pertaining to the selected radiography suitability instructing portion is proper or not is input to the control unit 31 (Step S205).

Whenever a radiography suitability signal is input, the control unit 31 associates the input radiography suitability signal with the key information pertaining to a corresponding reduced image, and makes the RAM 32 store the signal into the information storage region of the RAM 32 temporarily.

Incidentally, the key information received through the communication unit 36 is stored in a predetermined storage region of the RAM 32, for example.

After that, for example, when the transmission of the radiography suitability signal to the radiographic image detecting apparatus 2 is instructed, for example, depending on an operation of the operation input unit 35 by the user, the control unit 31 reads the radiography suitability signal having received the transmission instruction thereof and the key information corresponding to the radiography suitability signal from the RAM 32, and then the control unit 31 controls the communication unit 36 to transmit the read signal and information to the radiographic image detecting apparatus 2 (Step S206).

At Step S207, the control unit 31 judges whether the radiographic image information (original image) is received from the radiographic image detecting apparatus 2 or not. When the information is not received (Step S207: No), the control unit 31 keeps the state. When the information is received (Step S207: Yes), the control unit 31 shifts its processing to Step S208.

At Step S208, when the control unit 31 receives the radiographic image information (original image) transmitted from the communication unit 26 of the radiographic image detecting apparatus 2 through the communication unit 36, the control unit 31 reads the image processing program from the ROM 33, expands the read program in the RAM 32, and performs predetermined image processing such as the gradation processing, the y conversion processing and the like of the radiographic image pertaining to the received radiographic image information based on the radiographic image information according to the image processing program.

After that, the control unit 31 makes the image storage unit 38 store the radiographic image information after the image processing at a predetermined region of the image storage unit 38 (Step S209).

The operation of the server 4 is described.

Following the management program based on the identification information and the management information which have been obtained from radiographic image detecting apparatus 2, the control unit 41 of the server 4 makes the information storage unit 42 store the identification information and the management information, and thereby manages the radiographic image detecting apparatus 2 connected to the network N.

The control unit 41 makes the information storage unit 42 store the information such as a radiography day, the number of times of radiography of the radiography day, a maintenance day, the state of each portion of the radiographic image radiographing apparatus 1 at the time of the maintenance, a failure generating day, a failure generating part and the like every radiographic image detecting apparatus 2, i.e. every identification information of every radiographic image detecting apparatus 2. These pieces of information are preferably updated every day.

Then, the control unit 41 supplies the information stored by the information storage unit 42 in response to a request from the radiographic image detecting apparatus 2 or the console 3. Then, the console 3 judges and works using the supplied information. As the activity thereof, there can be cited, for example, making the information display on the display unit 34, controlling the radiographic image radiographing apparatus 1, controlling the radiographic image detecting apparatus 2, and the like. However, the activity is not limited to the activities mentioned above.

Then, the following is mentioned as an example that the console 3 displays on the display unit 34 by using information supplied from the server 4.

For example, when the console 3 has judged the necessity of maintenance using the information supplied from the server 4 and has judged that it is necessary to perform the maintenance of a certain radiographic image detecting apparatus 2, the console 3 makes the display unit 34 display a maintenance warning to the radiographic image detecting apparatus 2. In more concrete terms, for example, the console 3 judges whether the total number of times of radiography after the maintenance day at the last time exceeds a previously set threshold value or not, and makes the display unit 34 display the maintenance warning to the radiographic image detecting apparatus 2 the total number of times of radiography of which exceeds the threshold value. Moreover, for example, the console 3 judges whether a predetermined period has elapsed form the maintenance day at the last time or not, and makes the display unit 34 display the maintenance warning to the radiographic image detecting apparatus 2 for which the predetermined period has elapsed.

Moreover, for example, when a certain radiographic image detecting apparatus 2 judges that a fault arose in itself, the console 3 requires the information about the radiographic image detecting apparatus 2 from the server 4, receives the information, and makes the display unit 34 display the history information of the radiographic image detecting apparatus 2, the corresponding activity and the like using the received information.

Moreover, for example, when the console 3 judges that a fault arose in a certain radiographic image detecting apparatus 2, the console 3 requires the information about the radiographic image detecting apparatus 2 from the server 4. Then, the console 3 receives the information, specifies the necessary points to be checked of the radiographic image detecting apparatus 2 preferentially, and makes the display unit 34 display the radiographic image detecting apparatus 2 together with the specifying information so that the operator may understand the necessary points to be checked Wand the preferential order of the points. If various essential points are displayed in such a manner, because the operator can understand the matters which the operator should deal with, such as the exchange of the rechargeable battery 271, and the exchange and the maintenance of parts, the operator can deal with suitably.

Moreover, the following can be cited as an example of the console 3 controlling the radiographic image radiographing apparatus 1 by using the information supplied from the server 4.

For example, when the radiography characteristic of the radiographic image detecting apparatus 2 changes depending on the history thereof, the radiation radiating of the radiographic image radiographing apparatus 1 is controlled using the information supplied from the server 4. In more concrete terms, for example, when the radiography sensitivity of the radiographic image detecting apparatus 2 changes depending on the number of times of radiography, the console 3 uses the information supplied from the server 4 to calculate the total number of times of radiography, and controls the amount of the radiation radiating of the radiographic image radiographing apparatus 1 depending on the total number of times of radiography. Moreover, for example, when the accuracy of the timing control of the plane detector 24 increases depending on the number of lapsed days from the last maintenance day, the console 3 uses the information supplied from the server 4 to calculate the number of lapsed days from the last maintenance day, and controls the radiation radiating time or the radiation generating intensity of the radiographic image radiographing apparatus 1 depending on the number of lapsed days.

Moreover, the following can be cited as an example of the console 3 controlling the radiographic image detecting apparatus 2 by using the information supplied from the server 4.

For example, when the communication characteristic of the communication unit 26 of the radiographic image detecting apparatus 2 changes depending on the history thereof, the console 3 uses the information supplied from the server 4 to transmit the control information of the communication unit 26 of the radiographic image detecting apparatus 2 to the radiographic image detecting apparatus 2, and controls indirectly the communication unit 26 of the radiographic image detecting apparatus 2. Moreover, for example, when the characteristic of the rechargeable battery 271 of the radiographic image detecting apparatus 2 changes depending on the number of lapsed days from the last maintenance day (recharged day), the console 3 uses the information supplied from the server 4 to transmit the calculation information about the calculation of the number of remaining times capable of being radiographed to the radiographic image detecting apparatus 2. The radiographic image detecting apparatus 2 calculates the number of the remaining times capable of being radiographed based on the transmitted calculation information, and displays a warning display when the number of the remaining times capable of being radiographed becomes little. Thus, the radiographic image detecting apparatus 2 is controlled indirectly.

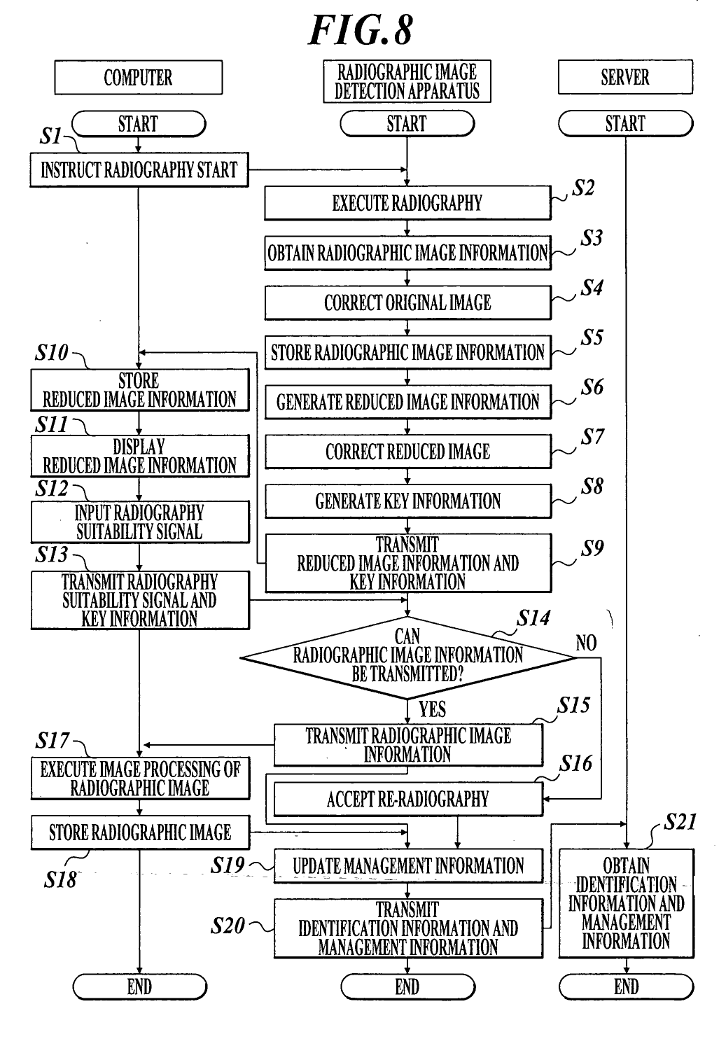

Next, the timing chart of FIG. 8 is referred to, and each operation of the console 3, the radiographic image detecting apparatus 2 and the server 4 in the radiography processing of a radiographic image is described. FIG. 8 is a timing chart showing an example of the operation pertaining to the radiography processing by the radiography system 100.

When a radiography start instruction is input to the console 3 (Step S1), radiation is radiated from the radiographic image radiographing apparatus 1 to a subject, and the radiography of the subject is performed using the radiographic image detecting apparatus 2 (Step S2). That is, the radiation which has transmitted the subject is detected with the plane detector 24 of the radiographic image detecting apparatus 2, and the detected radiation is converted into an electric signal to be stored in each pixel of the plane detector 24.

Next, the control unit 21 of the radiographic image detecting apparatus 2 obtains the radiographic image information of the subject from the plane detector 24 (Step S3). In concrete terms, the control unit 21 reads the obtainment control program from the ROM 23, expands the read program in the RAM 22, and controls the switching unit of each pixel of the plane detector 24 according to the obtainment control program to switch the reading of the electric signal stored in each pixel concerned sequentially. Thus, the control unit 21 reads all the electric signals stored in the plane detector 24.

Successively, the control unit 21 reads the radiographic image correction program from the ROM 23, expands the read program in the RAM 22, and performs the correction processing of an original image in which a predetermined image correction is performed to the obtained radiographic image information (original image) according to the radiographic image correction program (Step S4).

After that, the control unit 21 reads the image storage control program from the ROM 23, expands the read program in the RAM 22, and makes the image memory 25 store the radiographic image information (original image) and the accompanying information after the correction according to the image storage control program (Step S5).

Next, the control unit 21 reads the displaying information generation program from the ROM 23, expands the read program in the RAM 22, and generates reduced image information having a less amount of information than that of the radiographic image information as a displaying image to be output to the console 3 based on the obtained radiographic image information (original image) according to the displaying information generation program (Step S6).

Successively, the control unit 21 reads the displaying image correction program from the ROM 23, expands the read program in the RAM 22, and performs a predetermined image correction to the reduced image information according to the displaying image correction program (Step S7).

Incidentally, the generation and the correction of the reduced image information are performed every obtainment of the radiographic image information by the radiographic image detecting apparatus 2.

Next, the control unit 21 reads the associating program from the ROM 23, expands the read program in the RAM 22, and generates the key information for associating the reduced image information to be transmitted to the console 3 with the radiographic image information (original image) stored in the image memory 25 according to the associating program (Step S8).

After that, the control unit 21 controls the communication unit 26 to make communication unit 26 transmit the generated reduced image information, accompanying information, and the key information corresponding to the reduced image information to the console 3 (Step S9).

When the console 3 receives the reduced image information and the key information which have been transmitted from the communication unit 26 of the radiographic image detecting apparatus 2 through the communication unit 36, the control unit 31 of the console 3 stores the received reduced image information and the key information into the predetermined region of the RAM 32 (Step S10).

After that, when an image display instruction signal pertaining to a display instruction of the reduced image information stored in the RAM 32 is input based on an operation of the operation input unit 35, the control unit 31 obtains a plurality of reduced image information corresponding to the image display instruction signal from the RAM 32, and makes the display unit 34 display a plurality of reduced images based on the obtained reduced image information as thumbnails (Step S11). In concrete terms, the control unit 31 displays the plurality of reduced images and the radiography suitability instruction portions associated with the respective reduced images at the predetermined positions of the display unit 34. At this time, the accompanying information given to the reduced image information of each reduced image is displayed in association with the reduced image information.

Then, when a radiography suitability instruction portion displayed on the display unit 34 is selected and designated based on a predetermined operation of the operation input unit 35 by the user, a radiography suitability signal pertaining to whether the radiography state of the radiographic image pertaining to the selected radiography suitability instructing portion is proper or not is input to the control unit 31 (Step S12).

The control unit 31 makes the RAM 32 once store the input radiography suitability signal in the information storage region of the RAM 32 every input of the radiography suitability signal.

Incidentally, the key information received through the communication unit 36 is stored, for example, in the predetermined storage region of the RAM 32.

After that, for example, when a transmission of the radiography suitability signal to the radiographic image detecting apparatus 2 is instructed depending on an operation of the operation input unit 35 by the user, the control unit 31 reads the radiography suitability signal having received the transmission instruction and the key information corresponding to the radiography suitability signal from the RAM 32, and then the control unit 31 controls the communication unit 36 to make the communication unit transmit the read signal and information to the radiographic image detecting apparatus 2 (Step S13).

Then, when the radiographic image detecting apparatus 2 receives the radiography suitability signal and the key information transmitted from the communication unit 36 of the console 3 through the communication unit 26, the control unit 21 reads the judgment program from the ROM 23, expands the read program in the RAM 22, and judges whether to transmit the radiographic image information (original image) associated with the key information among the plurality of pieces of radiographic image information stored in the image memory 25 based on each radiography suitability signal and each key information according to the judgment program (Step S14). In concrete terms, when a signal including the information indicating that the radiography state of a radiographic image is proper is input as the radiography suitability signal, the control unit 21 judges to transmit radiographic image information (original image). On the other hand, when a signal including the information indicating that the radiography state of a radiographic image is not proper is input as the radiography suitability signal, the control unit 21 judges not to transmit the radiographic image information.

Here, when it is judged that the radiographic image information (original image) is transmitted to the console 3 (Step S14: Yes), the control unit 21 shifts its processing to Step S15. The control unit 21 obtains the radiographic image information (original image) from the image memory 25, and makes the communication unit 26 transmit the obtained radiographic image information (original image) to the console 3. After that, the control unit 21 shifts its processing to Step S19.

When the console 3 receives the radiographic image information (original image) transmitted from the communication unit 26 of the radiographic image detecting apparatus 2 through the communication unit 36, the control unit 31 of the console 3 reads the image processing program from the ROM 33, expands the read program in the RAM 32, and performs the predetermined image processing such as the gradation processing and the γ conversion of the radiographic image pertaining to the radiographic image information (original image) based on the received radiographic image information (original image) according to the image processing program (Step S17).

After that, the control unit 31 makes the image storage unit 38 store the radiographic image information (original image) after the image processing thereof to a predetermined region of the image storage unit 38 (Step S18) Hereupon, the control unit 21 of the radiographic image detecting apparatus 2 may be constructed to perform data deletion of the radiographic image information unnecessary to be transmitted to the console 3 when the radiographic image detecting apparatus 2 has received from the console 3 information indicative of having stored the radiographic image information in the image storage unit 38.

Incidentally, when the radiographic image information is judged not to be transmitted to the console 3 at Step S14, (Step S14; No), the control unit 21 shifts its processing to Step S19. Then, the control unit 21 controls each unit of the radiographic image detecting apparatus 2 to make them the acceptance state of re-radiography of a radiating image, and after that the control unit 21 shifts its processing to Step S19.

Hereupon, the control unit 21 may have the configuration in which the radiographic image information unnecessary for being transmitted to the console 3 is deleted.

Then, when the radiographic image information (original image) after the image processing is stored in the image storage unit 38 at Step S18, the control unit 21 of the radiographic image detecting apparatus 2 updates the management information changed by the radiography at this time, and makes the management information memory 28 store the updated management information (Step S19). After that, from the communication unit 26 of the radiographic image detecting apparatus 2, the updated management information and the identification information are transmitted to the server 4 (Step S20). Following the management program based on the obtained identification information and the obtained management information, the control unit 41 of the server 4 makes the information storage unit 42 store the updated management information and the updated identification information, and thereby manages the radiographic image detecting apparatus 2 (Step S21).

Incidentally, as for the radiography processing when a new radiographic image detecting apparatus 2 is connected to the network N, in each of the radiographing rooms R1, R2 and R3, when the new radiographic image detecting apparatus 2 is connected to the network N, identification information and management information are transmitted to the server 4 from the communication unit 26 of the new radiographic image detecting apparatus 2. The control unit 41 of the server 4 shifts its processing to Step S1 after the control unit 41 managed the radiographic image detecting apparatus 2 newly connected to the network N by making the information storage unit 42 store the identification information and the management information, following the management program based on the obtained identification information and the obtained management information.

As mentioned above, according to the radiography system 100 of the present embodiment, because the server 4 manages a plurality of radiographic image detecting apparatus 2 based on the identification information taken in from the ROM 23 of the radiographic image detecting apparatus 2, the plurality of radiographic image detecting apparatus 2 can be managed unitarily, and it can manage more efficiently than the case where it is managed by each console 3 of each of the radiographing rooms R1, R2, and R3. Furthermore, if a plurality of radiographic image detecting apparatus 2 can be unitarily managed, the information obtainment of each radiographic image detecting apparatus 2 can be performed easily. Consequently, a prior state check and the specification of the radiographic image detecting apparatus 2 which produced a trouble can also be easily performed as a result.

Moreover, because the server 4 is connected with a plurality of radiographic image detecting apparatus 2 and a plurality of consoles 3 through the network N, whenever the plurality of consoles 3 read the management information of the radiographic image detecting apparatus 2 based on identification information, the plurality of consoles 3 can always grasp the present condition. In particular, even if the radiographic image detecting apparatus 2 moves on the network N, it becomes possible to output the management information corresponding to the radiographic image detecting apparatus 2 to the console 3 at the moved place by confirming the identification information at the moved place. That is, as long as the radiographic image detecting apparatus 2 is located on the network N, it is easily manageable even if the radiographic image detecting apparatus 2 has moved.

Moreover, because the console 3 is also an image processing apparatus, even if the image processing apparatus is not connected to the network N as a separate body, the image processing of radiographic image information becomes possible, and the system configuration can be simplified.

Incidentally, it is needless to say that the present invention is not limited to the embodiment described above, and that the present invention can be changed suitably.

For example, in the radiography system 100 of the present embodiment, although the time when a new radiographic image detecting apparatus 2 is connected to the network N and the time when radiography has been completed and a radiographic image has been stored in the console 3 are exemplified to be cited as the timing when the identification information and the management information are transmitted from the communication unit 26 of the radiographic image detecting apparatus 2, the timing of the transmission may be always available, and, for example, a time of the commencement of work of the business on a day and a time of the closing thereof and the like can be cited besides the times mentioned above. If the identification information and the management information are transmitted at the time of the commencement of work, the server 4 can emit warning based on the battery data within the management information or cumulative number of times of radiography data before radiography, or image correction data can be returned, and the work of the day can be performed smoothly.

Moreover, although the configuration in which the server 4 is connected as a single body on the network N has been exemplified in the present embodiment, for example, one console 3 among a plurality of consoles 3 connected to the network N may operate as the management apparatus according to the present invention. In such a case, because one console 3 functions both as the radiography operation control apparatus and the management apparatus according to the present invention, the system configuration can be more simplified than the case where the management apparatus is installed as a single body. Furthermore, in this case, it is possible to input the identification information directly from the console 3 without using any communication line.

Furthermore, although the case where the correction of an original image or reduced images is performed in the radiographic image detecting apparatus 2 is exemplified to be described in the present embodiment, the correction of such images may be performed in the console 3. In such a case, the control unit 41 of the server 4 extracts the management information corresponding to the radiographic image detecting apparatus 2 among a plurality of pieces of management information stored in the information storage unit 42 based on the identification information of the radiographic image detecting apparatus 2 to be used for radiography, and transmits the extracted management information to the console 3. The control unit 31 of the console 3 obtains the image correcting data among the received management information, and performs a correction of an original image or a reduced image based on the image correcting data.

What is claimed is:

1. A radiography system, comprising:
a plurality of radiographic image detecting apparatus to obtain radiographic image information of a subject by radiography of the subject;
a radiography operation control apparatus able to control a radiography operation of at least one radiographic image detecting apparatus among the plurality of radiographic image detecting apparatus; and
a management apparatus to manage the plurality of radiographic image detecting apparatus, wherein each of the plurality of radiographic image detecting apparatus is provided with an individual information storage unit to store individual information of the radiographic image detecting apparatus, and the individual information storage unit stores at least identification information specific to each of the plurality of radiographic image detecting apparatus, and wherein
the management apparatus recognizes the identification information specific to each of the plurality of radiographic image detecting apparatus, and manages each of the plurality of radiographic image detecting apparatus based on the recognized identification information.

2. The radiography system of claim 1, further comprising a communication line connecting the at least one radiographic image detecting apparatus, the radiography operation control apparatus and the management apparatus, wherein
the management apparatus manages the plurality of radiographic image detecting apparatus based on the identification information via the communication line.

3. The radiography system of claim 1, comprising a plurality of the radiography operation control apparatus, wherein
one radiography operation control apparatus among the plurality of radiographing operation control apparatus functions also as the management apparatus.

4. The radiography system of claim 1, wherein the radiography operation control apparatus is an image processing apparatus to perform image processing to the radiographic image information obtained from the radiographic image detecting apparatus.

5. A management program of a radiography system for causing a computer, which is included in a management apparatus to manage a plurality of radiographic image detecting apparatus to obtain radiographic image information of a subject by radiography of the subject, to execute a method comprising:
recognizing identification information specific to each of the plurality of radiographic image detecting apparatus; and
managing each of the plurality of radiographic image detecting apparatus based on the recognized identification information.
